(19) United States
(12) Patent Application Publication
(10) Pub. No.: US 2017/0323628 A1
(43) Pub. Date: Nov. 9, 2017

(54) ROAD NOISE MASKING SYSTEM FOR A VEHICLE

(71) Applicant: GM GLOBAL TECHNOLOGY OPERATIONS LLC, Detroit, MI (US)

(72) Inventors: Frank C. Valeri, Novi, MI (US); Scott M. Reilly, Southfield, MI (US); Christopher A. Stirlen, Milford, MI (US)

(21) Appl. No.: 15/147,407

(22) Filed: May 5, 2016

(51) Int. Cl. G10K 11/175

(52) U.S. Cl. CPC G10K 11/175; G10K 2210/1282

(57) ABSTRACT

A method of masking road noise for a vehicle includes monitoring, through a processor, one or more vehicle mounted transducers for noise produced by an interaction between the vehicle and a road surface, detecting, through the processor, an audible signal having one of an undesirable frequency and an undesirable magnitude associated with the interaction between the vehicle and the road surface, generating, through the processor, a masking signal having a frequency that will mask the audible signal having the one of the undesirable frequency and undesirable magnitude, and emitting the masking signal through one or more vehicle speakers.

### FIELD OF THE INVENTION

The subject invention relates to the art of vehicles and, more particularly, to a road noise masking system for a vehicle.

### BACKGROUND

Vehicle owners may be concerned with undesirable sounds that may exist in a vehicle interior. Often times, the undesirable noise may be generated by an interaction between vehicle tires and a road surface. Variations in a road surface including changes in surface material, surface structure and the like produce varying sounds when engaged by the vehicle tires. Undesirable noises may be transmitted and amplified through various vehicle components including body and suspension components. When present, undesirable noise may detract from an overall enjoyment of the vehicle. Accordingly, it is desirable to provide a cost-effective system that promotes a more enjoyable interior environment for the vehicle.

### SUMMARY OF THE INVENTION

In accordance with an exemplary embodiment, a method of masking road noise for a vehicle includes monitoring, through a processor, one or more vehicle mounted transducers for noise produced by an interaction between the vehicle and a road surface, detecting, through the processor, an audible signal having one of an undesirable frequency and an undesirable magnitude associated with the interaction between the vehicle and the road surface, generating, through the processor, a masking signal having a frequency that will mask the audible signal having the one of the undesirable frequency and undesirable magnitude, and emitting the masking signal through one or more vehicle speakers.

In accordance with another aspect of an exemplary embodiment, a road noise masking system for a vehicle includes a controller having a non-volatile memory, and a computer processor unit (CPU) having a computer readable program code embodied therewith. The computer readable program code, when executed by the CPU, causes the CPU to monitor, through the CPU, one or more vehicle mounted transducers for noise produced by an interaction between the vehicle and a road surface, detect, through the CPU, an audible signal having at least one of an undesirable frequency and an undesirable magnitude associated with the interaction between the vehicle and the road surface, generate, through the CPU, a masking signal having a frequency that will mask the audible signal having the one of the undesirable frequency and the undesirable magnitude, and emit the masking signal through one or more vehicle speakers.

In accordance with yet another aspect of an exemplary embodiment, a vehicle includes a body having an exterior portion and an interior portion. One or more transducers are arranged at one of the exterior portion and the interior portion. A road noise masking system is arranged in the vehicle. The road noise masking system includes a controller including a non-volatile memory, and a computer processor unit (CPU) having a computer readable program code embodied therewith. The computer readable program code, when executed by the CPU, causes the CPU to monitor, through the CPU, the one or more transducers for noise produced by an interaction between the vehicle and a road surface, detect, through the CPU, an audible signal having one of an undesirable frequency and an undesired magnitude associated with the interaction between the vehicle and the road surface, generate, through the CPU, a masking signal having a frequency that will mask the audible signal having the one of the undesirable frequency and the undesirable magnitude, and emit the masking signal through one or more vehicle speakers.

The above features and advantages and other features and advantages of the exemplary embodiment(s) are readily apparent from the following detailed description of the exemplary embodiment(s) when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a schematic representation of a vehicle including a road noise masking system, in accordance with an exemplary embodiment;

FIG. 2 is a schematic representation of a noise masking system, in accordance with an aspect of an exemplary embodiment;

FIG. 3 is a flow chart illustrating a method of masking undesirable road noise, in accordance with an aspect of an exemplary embodiment; and

FIG. 4 is a graph illustrating a masking signal of the noise masking system, in accordance with an aspect of an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term “module” or “unit” refers to an application specific integrated circuit (ASIC), a field programmable gate array (FPGA), an electronic circuit, an electronic computer processor (shared, dedicated, or group) and memory that executes one or more software or firmware programs, a hardware microcontroller, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

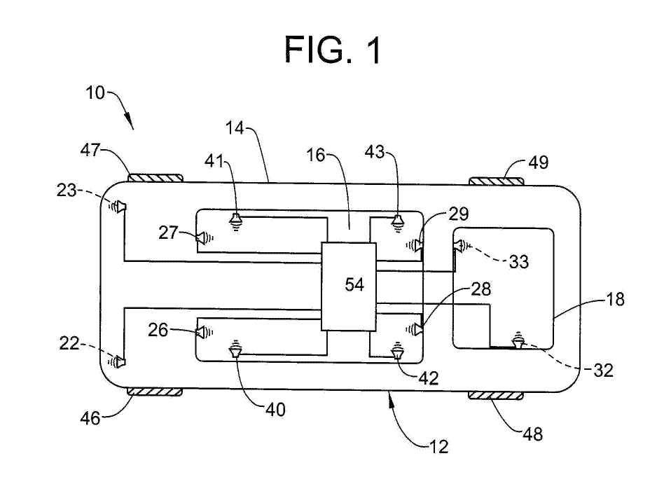

A vehicle, in accordance with an exemplary embodiment, is indicated generally at 10 in FIG. 1. Vehicle 10 includes a body 12 having an exterior portion 14, an interior portion 16 and an engine compartment 18. A plurality of transducers or sensors, two of which are shown at 22 and 23 may be arranged about exterior portion 14. Transducers 22 and 23 may take the form of accelerometers. Additional transducers, four of which are indicated at 26-29 may be arranged about interior portion 16, and transducers 32 and 33 may be arranged in engine compartment 18. Transducers 26-29 may take the form of microphones. Transducers 22, 23, 26-29 and/or 32-33 may form part of an active noise cancellation system (not shown). In addition, vehicle 10 includes a plurality of speakers, four of which are indicated at 40-43 arranged about interior portion 16. Vehicle 10 is supported by four tires 46-49 that, during vehicle travel, may generate undesirable road noise through an interaction between tire tread (not separately labeled) and a road surface (not separately labeled). Tire pressure may also contribute to undesirable noise as tires 46-49 interact with the road surface.

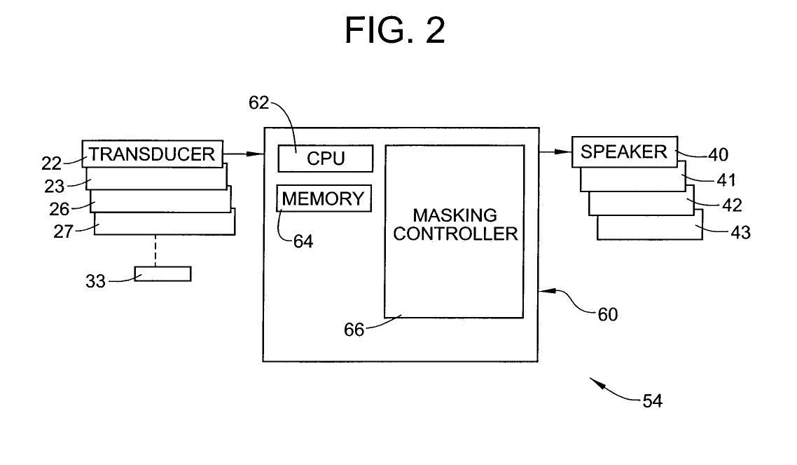

In accordance with an aspect of an exemplary embodiment, vehicle 10 includes a road noise masking system 54 that is operatively associated with transducers 22, 23, 26-29 and/or 32-33 and speakers 40-43. As shown in FIG. 2, road noise masking system 54 includes a controller 60 having a central processing unit (CPU) 62, a non-volatile memory 64 and a masking controller 66. As will be detailed more fully below, road noise masking system 54 monitors transducers 22, 23, 26-29 and/or 32-33 as vehicle travels over a road surface. If audible signals captured by one or more of transducers 22, 23, 26-29 and/or 32-33 are deemed to be undesirable, road noise masking system 54 emits a masking signal through one or more of speakers 40-43. The term undesirable, should be understood to describe an audible signal having a particular frequency and/or above particular decibel threshold that would be objectionable to passengers of vehicle 10.

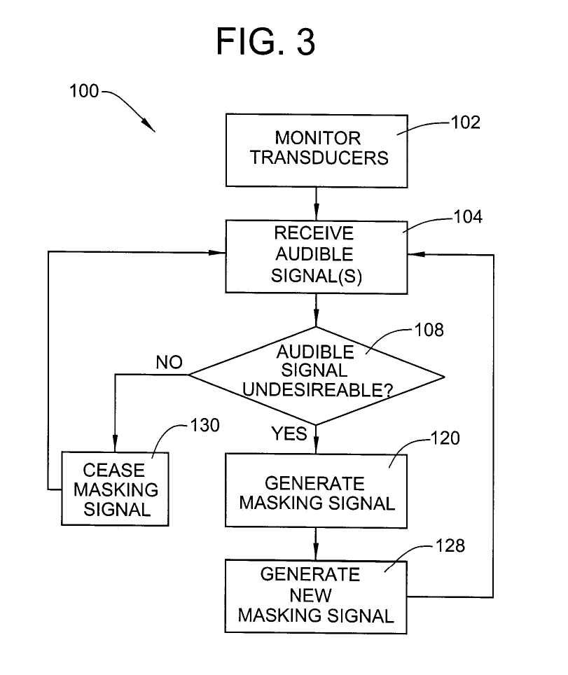

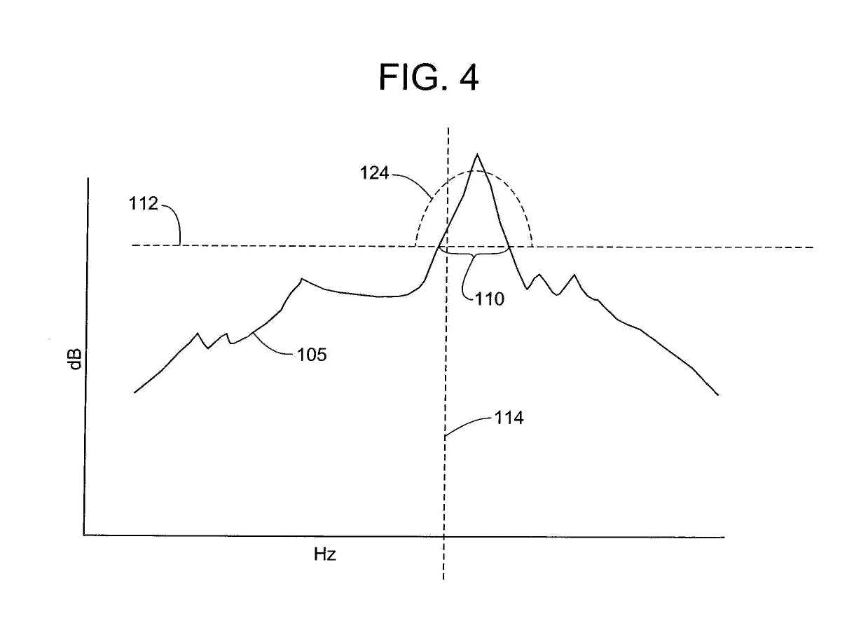

In accordance with an aspect of an exemplary embodiment, a method of detecting and masking undesirable road noise is indicated generally at 100 in FIG. 3. In block 102, road noise masking system 54 monitors one or more of transducers 22, 23, 26-29 and/or 32-33. In block 104, an audible signal 105 (FIG. 4) is received by road noise masking system 54 through one or more of transducers 22, 23, 26-29 and/or 32-33. Masking controller 66 may monitor specific frequencies known to be associated with undesirable sounds. For example, during design, construction and/or testing of vehicle 10, a determination may be made that undesirable sounds may possess a particular frequency or exist in a particular frequency band.

In block 108, a determination is made whether a portion 110 of audible signal 105 exists at an undesirable frequency and/or magnitude. For example, masking controller 66 determines that portion 110 of audible signal 105 possesses a bandwidth having an undesirable center frequency. Masking controller 66 may also determine that portion 110 of audible signal 105 possesses an undesirable magnitude. Masking controller 66 may further determine that the portion 110 of audible signal 105 possesses both an undesirable center frequency and an undesirable magnitude. In accordance with an aspect of exemplary embodiment, masking controller 66 may access non-volatile memory 64 and compare portion 110 of audible signal 105 against an predetermined undesirable magnitude threshold 112 (FIG. 4) associated with a particular frequency.

Of course, the predetermined undesirable magnitude threshold may vary depending on the particular frequency. In accordance with another aspect of an exemplary embodiment, masking controller 66 may access non-volatile memory 64 and compare portion 110 of audible signal 105 against a predetermined undesirable frequency threshold 114 (FIG. 4). The undesirable frequency threshold may represent one or more frequency bands that are determined to exist during design, construction and or testing of vehicle 10.

If, in block 108 portion 110 of audible signal 105 is determined to possess the undesirable frequency and/or undesirable magnitude, in block 120 masking controller 66 generates a masking signal 124. Masking signal 124 may constitute a broadband signal. More specifically, masking signal 124 includes a frequency band that is larger than a frequency band of portion 110. Controller 60 directs speakers 40-43 to emit masking signal 124 into interior portion 16 of vehicle 10. Masking signal 124 is designed to create an audible distraction that causes vehicle occupants to focus on a total noise characteristic that distracts from a narrow band undesirable frequency output. While emitting masking signal 124, road noise masking system 54 continues to monitor one or more of transducers 22, 23, 26-29 and/or 32-33 for changes in audible signal 105. If changes in audible signal 105 constitute a new undesirable frequency and/or magnitude as determined in block 108, a new masking signal may be generated in block 120 and emitted in block 128. If, audible signal 105 is determined not to exist at an undesirable frequency and/or magnitude, or audible signal 105 changes such that portion 110 of audible signal no longer exists at an undesirable frequency and/or undesirable magnitude, road noise masking system 54 either does not generate a masking signal or ceases to emit the masking signal in block 130.

At this point, it should be understood that the road noise masking system of the exemplary embodiments employs existing transducers to monitor road noise that may enter a passenger compartment of a vehicle. The existing transducers may be part of an active noise cancellation system (ANC) associated with the vehicle. If an undesirable signal is detected, the masking system generates a broadband masking signal. The broadband masking signal is designed to trick or to distract vehicle occupants brains to ignore undesirable signals. In this manner, the road noise masking system of the exemplary embodiments represents a cost effective system that improves an overall vehicle occupant experience during travel.

While the exemplary embodiment has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the exemplary embodiment without departing from the essential scope thereof. Therefore, it is intended that the exemplary embodiment not be limited to the particular embodiments disclosed, but that the exemplary embodiment will include all embodiments falling within the scope of the application.

1. A method of masking road noise for a vehicle comprising:
monitoring, through a processor, one or more vehicle mounted transducers for noise produced by an interaction between the vehicle and a road surface;
receiving through at least one of the one or more vehicle mounted transducers an audible signal of the noise produced by the interaction between the vehicle and the road surface;
determining, through the processor, that the audible signal includes one of an undesirable frequency and an undesirable magnitude associated with the interaction between the vehicle and the road surface;
generating, through the processor, a masking signal having a frequency that will mask the audible signal having the one of the undesirable frequency and undesirable magnitude; and
emitting the masking signal through one or more vehicle speakers.

2. The method of claim 1, further comprising:
detecting, through the processor, a change in the audible signal having the one of the undesirable frequency and undesirable magnitude;
determining, through the processor, that the change in the audible signal is above one of an undesirable frequency threshold and an undesirable magnitude threshold;
generating, through the processor, a new masking signal associated with the change in the audible signal; and
emitting the new masking signal through the vehicle speakers.

3. The method of claim 1, further comprising:
detecting, through the processor, a change in the audible signal having the one of the undesirable frequency and undesirable magnitude;
determining, through the processor, that the change in the audible signal is below one of a predetermined undesirable frequency threshold and an undesirable magnitude threshold; and
stopping emission of the masking signal.

4. The method of claim 1, wherein generating, through the processor, the masking signal includes generating a masking signal having a bandwidth that is greater than a bandwidth of the audible signal having the one of the undesirable frequency and undesirable magnitude.

5. The method of claim 1, wherein monitoring, through a processor, the one or more vehicle mounted transducers includes monitoring predetermined frequency bands associated with the vehicle.

6. The method of claim 1, wherein generating, through the processor, the masking signal includes determining a center frequency of the audible signal.

7. The method of claim 1, wherein detecting, through the processor, an audible signal having the one of the undesirable frequency and undesirable magnitude includes detecting an audible signal having both of the one of the undesirable frequency and undesirable magnitude.

8. A road noise masking system for a vehicle comprising:
a controller including a non-volatile memory, and a computer processor unit (CPU) having a computer readable program code embodied therewith, the computer readable program code, when executed by the CPU, causes the CPU to:
monitor, through the CPU, one or more vehicle mounted transducers for noise produced by an interaction between the vehicle and a road surface;
receive through at least one of the one or more vehicle mounted transducers an audible signal of the noise produced by the interaction between the vehicle and the road surface;
determine, through the CPU, that the audible signal includes at least one of an undesirable frequency and an undesirable magnitude associated with the interaction between the vehicle and the road surface;
generate, through the CPU, a masking signal having a frequency that will mask the audible signal having the one of the undesirable frequency and the undesirable magnitude; and
emit the masking signal through one or more vehicle speakers.

9. The system of claim 8, wherein the computer readable program code, when executed by the CPU, causes the CPU to:
detect, through the CPU, a change in the audible signal having the one of the undesirable frequency and the undesirable magnitude;
determine, through the CPU, that the change in the audible signal is above one of an undesirable frequency threshold and an undesirable magnitude threshold;
generate, through the CPU, a new masking signal associated with the change in the audible signal; and
emit the new masking signal through the vehicle speakers.

10. The system of claim 8, the computer readable program code, when executed by the CPU, causes the CPU to:
detect, through the CPU, a change in the audible signal having the one of the undesirable frequency and the undesirable magnitude;
determine, through the CPU, that the change in the audible signal is below one of a predetermined undesirable frequency threshold and an undesirable magnitude threshold; and
stop emission of the masking signal.

11. The system of claim 8, wherein the computer readable program code, when executed by the CPU, causes the CPU to: generate a masking signal having a bandwidth that is greater than a bandwidth of the audible signal having the one of the undesirable frequency and the undesirable magnitude when generating the masking signal.

12. The system of claim 8, wherein the computer readable program code, when executed by the CPU, causes the CPU to monitor predetermined frequency bands associated with the vehicle when monitoring the vehicle mounted transducers.

13. The system of claim 8, wherein the computer readable program code, when executed by the CPU, causes the CPU to: determine a center frequency of the audible signal when generating the masking signal.

14. The system of claim 8, wherein the computer readable program code, when executed by the CPU, causes the CPU to: detect an audible signal that possesses an undesirable frequency and an undesirable magnitude when detecting the audible signal having an undesirable frequency.

15. A vehicle comprising:
a body having an exterior portion and an interior portion;
one or more transducers arranged at one of the exterior portion and the interior portion; and
a road noise masking system arranged in the vehicle, the road noise masking system comprising:
a controller including a non-volatile memory, and a computer processor unit (CPU) having a computer readable program code embodied therewith, the computer readable program code, when executed by the CPU, causes the CPU to:
monitor, through the CPU, the one or more transducers for noise produced by an interaction between the vehicle and a road surface;
receive through at least one of the one or more vehicle mounted transducers an audible signal of the noise produced by the interaction between the vehicle and the road surface;
determine, through the CPU, that the audible signal includes one of an undesirable frequency and an undesired magnitude associated with the interaction between the vehicle and the road surface;
generate, through the CPU, a masking signal having a frequency that will mask the audible signal having the one of the undesirable frequency and the undesirable magnitude; and
emit the masking signal through one or more vehicle speakers.

16. The vehicle according to claim 15, wherein the computer readable program code, when executed by the CPU, causes the CPU to:
detect, through the CPU, a change in the audible signal having the one of the undesirable frequency and the undesirable magnitude;
determine, through the CPU, that the change in the audible signal is above one of an undesirable frequency threshold and an undesirable magnitude threshold;
generate, through the CPU, a new masking signal associated with the change in the audible signal; and
emit the new masking signal through the vehicle speakers.

17. The vehicle according to claim 15, the computer readable program code, when executed by the CPU, causes the CPU to:
detect, through the CPU, a change in the audible signal having the one of the undesirable frequency and the undesirable magnitude;
determine, through the CPU, that the change in the audible signal is below one of a predetermined undesirable frequency threshold and a predetermined undesirable magnitude threshold; and
stop emission of the masking signal.

18. The vehicle according to claim 15, wherein the computer readable program code, when executed by the CPU, causes the CPU to: generate a masking signal having a bandwidth that is greater than a bandwidth of the audible signal having the one of the undesirable frequency and the undesirable magnitude when generating the masking signal.

19. The vehicle according to claim 15, wherein the computer readable program code, when executed by the CPU, causes the CPU to monitor predetermined frequency bands associated with the vehicle when monitoring the vehicle mounted transducers.

20. The vehicle according to claim 16, wherein the computer readable program code, when executed by the CPU, causes the CPU to: detect an audible signal that possesses an undesirable frequency and an undesirable magnitude when detecting the audible signal having an undesirable frequency.
